(19) United States
(12) Patent Application Publication
(10) Pub. No.: US 2026/0184300 A1
(43) Pub. Date: Jul. 2, 2026

(54) VEHICLE AND VEHICLE CONTROL METHOD

(71) Applicant: KAWASAKI MOTORS, LTD., Akashi-shi (JP)

(72) Inventors: Rui FUKUOKA, Akashi-shi (JP); Naoya ISOZAKI, Akashi-shi (JP); Koshi FUSAZAKI, Akashi-shi (JP)

(21) Appl. No.: 19/430,789

(22) Filed: Dec. 23, 2025

(30) Foreign Application Priority Data
Dec. 27, 2024 (JP) 2024-232991

(51) Int. Cl. B60W 20/19; B60W 20/30; B60W 30/182

(52) U.S. Cl. CPC B60W 20/19; B60W 20/30; B60W 30/182; B60W 2510/1005; B60W 2510/1015; B60W 2510/246

(57) ABSTRACT

There is provided a vehicle including: a wheel; a traveling drive source configured to drive the wheel; an input interface configured to receive an input of an operation for accelerating the vehicle; and a control circuitry configured to control the traveling drive source based on an operation amount input to the input interface. The control circuitry is configured to: determine a reference output that is an output of the traveling drive source based on the operation amount; determine whether at least two preset assist conditions are satisfied; execute assist control to control the traveling drive source based on an assist output increased from the reference output when the at least two assist conditions are satisfied; and execute normal control to control the traveling drive source based on the reference output when the number of the satisfied assist conditions is less than two.

### CROSS-REFERENCE TO RELATED APPLICATIONS

This application is based on and claims priority under 35 USC 119 from Japanese Patent Application No. 2024-232991 filed on Dec. 27, 2024, the contents of which are incorporated herein by reference.

### TECHNICAL FIELD

The present disclosure relates to a vehicle and a vehicle control method.

### BACKGROUND ART

JP4182068B2 discloses torque assist control for a hybrid vehicle that corrects a reference output of a drive motor based on an accelerator operation amount by adding an additional value. The additional value is a value corresponding to a difference obtained by subtracting a threshold corresponding to a vehicle speed from a change rate of the accelerator operation amount.

### SUMMARY OF INVENTION

In JP4182068B2, the magnitude of the additional value and the timing of adding the additional value to the reference output depend on the change rate of the accelerator operation amount and the vehicle speed.

An object of one aspect of the present disclosure is to provide a vehicle and a vehicle control method that implement new assist control.

According to an illustrative aspect of the present disclosure, a vehicle includes: a wheel; a traveling drive source configured to drive the wheel; a first input interface configured to receive an input of an operation for accelerating the vehicle; and a control circuitry configured to control the traveling drive source based on an operation amount input to the first input interface. The control circuitry is configured to: determine a reference output that is an output of the traveling drive source based on the operation amount; determine whether at least two preset assist conditions are satisfied; execute assist control to control the traveling drive source based on an assist output increased from the reference output when the at least two assist conditions are satisfied; and execute normal control to control the traveling drive source based on the reference output when the number of the satisfied assist conditions is less than two.

### BRIEF DESCRIPTION OF DRAWINGS

FIG. 1 is a side view illustrating an example of a configuration of a vehicle according to an exemplary embodiment;

FIG. 2 is a schematic diagram illustrating an example of a power system of the vehicle illustrated in FIG. 1;

FIG. 3 is a diagram illustrating an example of a relation among a filter coefficient in low-pass filter processing according to the embodiment, a pre-processing throttle opening degree, and a post-processing throttle opening degree;

FIG. 4 is a diagram illustrating an example of a relation between a change amount threshold and a throttle opening degree;

FIG. 5 is a diagram illustrating an example of control steps related to assist control of an ECU according to the embodiment;

FIG. 6 is a flowchart illustrating an example of a flow of an operation of the ECU according to the embodiment; and

FIG. 7 is a flowchart illustrating an example of the flow of the operation of the ECU according to the embodiment.

### DESCRIPTION OF EMBODIMENTS

Hereinafter, exemplary embodiments of the present disclosure will be described with reference to the drawings. The embodiments described below each show a comprehensive or specific example. Among the components in the following embodiments, components that are not described in an independent claim indicating a broadest concept are described as optional components. Each drawing in the accompanying drawings is a schematic diagram and is not necessarily strictly illustrated. In the drawings, substantially the same components are denoted by the same reference numerals, and redundant description may be omitted or simplified.

Hereinafter, a vehicle 1 according to an exemplary embodiment will be described. The vehicle 1 is a moving body that can move while carrying one or more people. The vehicle 1 includes wheels as moving units. Examples of the vehicle 1 may include a two-wheeled vehicle, a three-wheeled vehicle, and a four-wheeled vehicle. In the present embodiment, the vehicle 1 is a motorcycle.

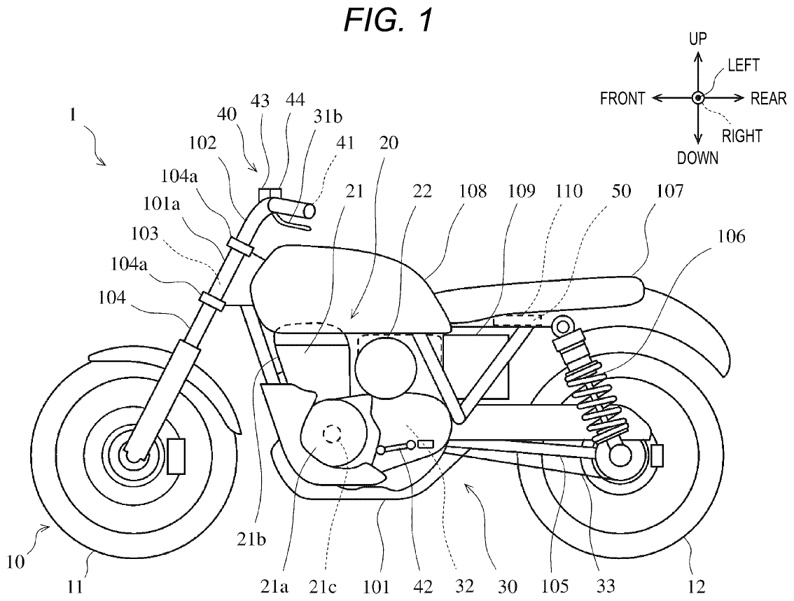

FIG. 1 is a side view illustrating an example of a configuration of the vehicle 1 according to the exemplary embodiment. As illustrated in FIG. 1, the vehicle 1 includes wheels 10, a traveling drive source 20, a drive structure 30, input interface 40, and a control circuitry 50. In the present embodiment, the vehicle 1 includes a front wheel 11 and a rear wheel 12 as the wheels 10. Further, the vehicle 1 includes an internal combustion engine 21 and a rotary electric machine 22 as the traveling drive source 20. The vehicle 1 further includes a throttle grip 41 as the input interface 40. The throttle grip 41 is one of first input interface. The throttle grip 41 receives an input of an operation of accelerating or decelerating the vehicle 1 from the driver.

The internal combustion engine 21 converts thermal energy obtained by burning fuel into mechanical rotational energy. In the present embodiment, the internal combustion engine 21 is a reciprocating engine. The internal combustion engine 21 transmits, to the drive structure 30, rotational power of a crankshaft 21c generated by repeating combustion and explosion of a mixed gas of fuel and air in a cylinder of a cylinder block 21b. The rotational power transmitted to the drive structure 30 is transmitted to the rear wheel 12, which is a drive wheel, and the rear wheel 12 is driven by the rotational power to move the vehicle 1.

The rotary electric machine 22 has a power generation function of converting electric energy into mechanical rotational energy. Further, the rotary electric machine 22 has an electric power generation function of converting mechanical rotational energy into electric energy. The rotary electric machine 22 converts electric energy into rotational motion of a drive shaft thereof and transmits the rotational power of the drive shaft to the drive structure 30. The rotational power transmitted to the drive structure 30 is transmitted to the rear wheel 12.

In the present embodiment, the vehicle 1 is a hybrid vehicle that travels using one or both of the rotational power output by the internal combustion engine 21 and the rotational power output by the rotary electric machine 22.

Here, in the present specification, an upward direction, a downward direction, a forward direction, a rearward direction, a leftward direction, and a rightward direction are directions based on the vehicle 1 in a state of being disposed upright on the ground extending horizontally. The upward direction refers to a direction from the ground toward the vehicle 1, and the downward direction refers to a direction from the vehicle 1 toward the ground. The forward direction refers to a forward direction of the vehicle 1. The rearward direction, the leftward direction, and the rightward direction indicate corresponding directions with respect to the driver straddling the vehicle 1 standing upright on the ground.

The vehicle 1 further includes a vehicle body frame 101, a handle 102, a steering shaft 103, a pair of left and right front forks 104, a swing arm 105, rear suspensions 106, a seat 107, a fuel tank 108, a battery 109, and an electronic control unit 110. The electronic control unit 110 is also referred to as an ECU. Hereinafter, the “electronic control unit 110” may be referred to as “ECU 110”.

An upper portion of the front fork 104 is coupled to a pair of brackets 104a disposed at an interval in an up-down direction, and a lower portion of the front fork 104 rotatably supports the front wheel 11. The bracket 104a is connected to the steering shaft 103 that supports the handle 102. The steering shaft 103 is supported by a head pipe 101a, which is a part of the vehicle body frame 101, so as to be angularly displaceable. The swing arm 105 supports the rear wheel 12, extends in a front-rear direction, and is pivotally supported by the vehicle body frame 101. The rear suspension 106 is connected to the swing arm 105 and the vehicle body frame 101.

In an upper portion of the vehicle body frame 101, the fuel tank 108 is positioned behind the handle 102, and the seat 107 on which the driver sits is positioned behind the fuel tank 108.

In the present embodiment, the battery 109 and the ECU 110 are disposed below the seat 107. The battery 109 includes a plurality of secondary battery cells capable of charging and discharging electric power. The battery 109 stores electric power generated by the electric power generation function of the rotary electric machine 22, and supplies the stored electric power to electrical components that use electric power in the vehicle 1. The rotary electric machine 22 is one of electrical components to which electric power is supplied from the battery 109.

The ECU 110 controls the vehicle 1. The ECU 110 includes the control circuitry 50.

The internal combustion engine 21 and the rotary electric machine 22 are disposed in a space surrounded by the vehicle body frame 101 between the front wheel 11 and the rear wheel 12, and are fixed to the vehicle body frame 101 at a plurality of portions.

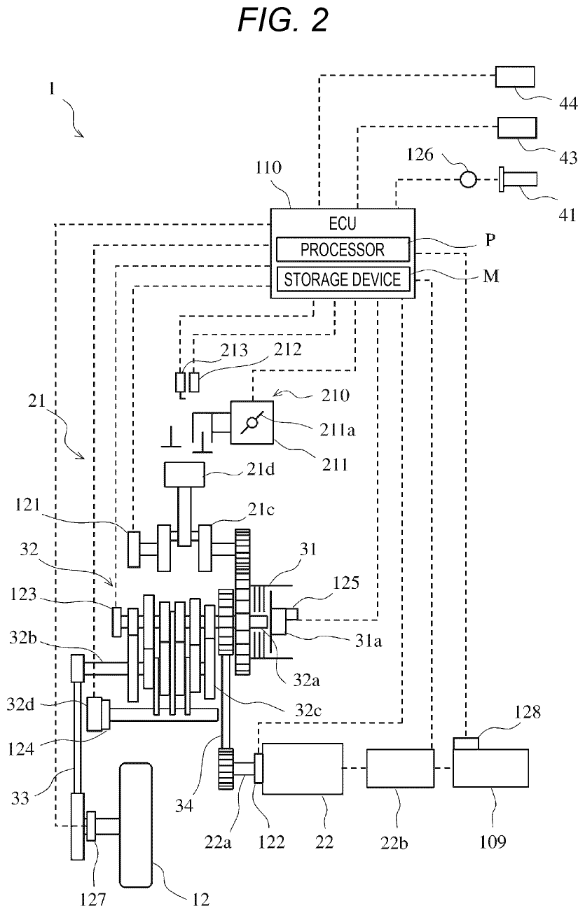

FIG. 2 is a schematic diagram illustrating an example of a power system of the vehicle 1 illustrated in FIG. 1. As illustrated in FIGS. 1 and 2, the internal combustion engine 21 includes the crankshaft 21c in a crankcase 21a, and one or more pistons 21d slidably disposed in the cylinder block 21b and connected to the crankshaft 21c so as to be capable of transmitting a driving force. The internal combustion engine 21 causes the piston 21d to reciprocate by repeating combustion and explosion of a mixed gas of fuel and air in the cylinder of the cylinder block 21b. The internal combustion engine 21 converts reciprocating motion of the piston 21d due to combustion and explosion into rotational motion of the crankshaft 21c and outputs the rotational power of the crankshaft 21c.

The drive structure 30 includes a clutch 31, a transmission 32, and a power transmission member 33. The transmission 32 includes an input shaft 32a, an output shaft 32b, and a plurality of gears 32c disposed on the input shaft 32a and the output shaft 32b. The transmission 32 can change a reduction ratio between rotational power input to the input shaft 32a and rotational power output from the output shaft 32b by changing a combination of the gears 32c that transmit power from the input shaft 32a to the output shaft 32b. For example, a high reduction ratio is a reduction ratio for low-speed traveling, and a low reduction ratio is a reduction ratio for high-speed traveling. The input shaft 32a is connected to the clutch 31. Further, the clutch 31 is connected to the crankshaft 21c. Thus, the input shaft 32a is connected to the crankshaft 21c via the clutch 31 in a power transmittable manner. The output shaft 32b is connected to the power transmission member 33.

In the present embodiment, the drive structure 30 includes a transmission actuator 32d that controls the reduction ratio selected by the transmission 32. For example, the transmission actuator 32d moves the gear 32c of the input shaft 32a or the output shaft 32b in an axial direction, and changes the set of gears 32c engaged so as to transmit the rotational power between the input shaft 32a and the output shaft 32b. In the present embodiment, the transmission actuator 32d moves a shift fork in the axial direction by rotating a shift drum included in the transmission 32, thereby moving the gear 32c by the shift fork. The operation of the transmission actuator 32d is controlled by ECU 110.

The power transmission member 33 includes a plurality of members that connect the output shaft 32b and the rear wheel 12. For example, the power transmission member 33 includes a sprocket or a pulley connected to the output shaft 32b, a sprocket or a pulley connected to the rear wheel 12, and a chain or a belt wound around two sprockets or two pulleys. Thus, the output shaft 32b is connected to the rear wheel 12 via the power transmission member 33 in a power transmittable manner.

The clutch 31 has a structure that engages and disengages power transmission between the crankshaft 21c and the input shaft 32a. In the present embodiment, the drive structure 30 includes a clutch actuator 31a that controls driving of the clutch 31 between an engaged state and a disengaged state. When the clutch 31 is in the engaged state, the rotational power of the internal combustion engine 21 is transmitted to the rear wheel 12. When the clutch 31 is in the disengaged state, the rotational power of the internal combustion engine 21 is not transmitted to the rear wheel 12. The operation of the clutch actuator 31a is controlled by ECU 110.

The rotary electric machine 22 includes a drive shaft 22a that rotates by receiving supply of electric power. The rotary electric machine 22 generates electric power by rotating the drive shaft 22a, and supplies the generated electric power to the battery 109. The drive shaft 22a is connected to the input shaft 32a of the transmission 32 via a power transmission member 34 in a power transmittable manner. Examples of the power transmission member 34 may include a chain, a belt, a gear, and a pulley. The connection structure of the power transmission member 34 may be similar to that of the power transmission member 33. The drive shaft 22a of the rotary electric machine 22 is connected to the input shaft 32a regardless of whether the clutch 31 is in the engaged state or the disengaged state. Therefore, the rotary electric machine 22 transmits the rotational power to the rear wheel 12 via the transmission 32 by receiving the supply of electric power. The rotary electric machine 22 generates electric power by forcibly rotating the drive shaft 22a by the rear wheel 12 via the transmission 32.

The vehicle 1 includes a drive circuit 22b of the rotary electric machine 22. The drive circuit 22b controls electric power exchange between the battery 109 and the rotary electric machine 22 under the control of the ECU 110. The drive circuit 22b controls the rotary electric machine 22 by controlling electric power supplied from the battery 109 to the rotary electric machine 22. The drive circuit 22b controls the rotation speed of the rotary electric machine 22 by controlling the voltage of electric power supplied to the rotary electric machine 22. The drive circuit 22b controls an output torque of the rotary electric machine 22 by controlling the current of the electric power supplied to the rotary electric machine 22. The drive circuit 22b may include an inverter or a converter that converts electric power between DC electric power and AC electric power.

The vehicle 1 as described above is a parallel hybrid vehicle. However, the vehicle 1 may be a hybrid vehicle of another type such as a split type. The vehicle 1 travels by driving one or both of the internal combustion engine 21 and the rotary electric machine 22 in accordance with the traveling state of the vehicle 1. In the present embodiment, the vehicle 1 travels in a drive mode selected from a hybrid electric vehicle (HEV) mode, a charging mode, and an electric vehicle (EV) mode. In the HEV mode, the clutch 31 is in the engaged state, and the vehicle 1 can travel using the power of both the internal combustion engine 21 and the rotary electric machine 22. In the EV mode, the clutch 31 is in the disengaged state, and the vehicle 1 can travel using only the power of the rotary electric machine 22. In the charging mode, the clutch 31 is in the engaged state, the vehicle 1 travels using only the power of the internal combustion engine 21, and the rotary electric machine 22 is forcibly rotationally driven by the internal combustion engine 21 to generate electric power.

In the present embodiment, the vehicle 1 operates in a shift mode selected from a manual shift mode and an automatic shift mode. Therefore, the vehicle 1 includes a manual shift structure for the driver to directly operate to drive the clutch 31 and the transmission 32, and an automatic transmission structure for driving the clutch 31 and the transmission 32 without depending on the driver's operation. The automatic transmission structure is implemented by the clutch actuator 31a, the transmission actuator 32d, the ECU 110, and the like.

The vehicle 1 includes a clutch lever 31b and a shift operator 42 as elements for implementing the manual shift structure. The clutch lever 31b is an operator that receives an input of a driver's operation of engaging and disengaging the clutch 31. The clutch lever 31b is disposed on the handle 102. In the present embodiment, the clutch lever 31b is mechanically connected to the clutch 31. The operation of the clutch lever 31b given by the driver's operation is mechanically transmitted to the clutch 31 to engage and disengage the clutch 31. The clutch lever 31b may be electrically connected to the ECU 110. A signal indicating the operation of the clutch lever 31b may be output to the ECU 110, and the ECU 110 may control the clutch actuator 31a to engage or disengage the clutch 31 in accordance with the signal.

The shift operator 42 is one of the input interface 40 and is also one of second input interface. The shift operator 42 is an operator that receives an input of an operation of designating a reduction ratio selected by the transmission 32. The shift operator 42 may be a shift pedal disposed on the vehicle body frame 101 or the like, or a shift button or a shift lever disposed on the handle 102 or the like. In the present embodiment, the shift operator 42 is a shift pedal and is mechanically connected to the transmission 32. The operation of the shift operator 42 given by the driver's operation is mechanically transmitted to the transmission 32 to change the reduction ratio selected by the transmission 32. The shift operator 42 may be electrically connected to the ECU 110. A signal indicating an input given to the shift operator 42 may be output to the ECU 110, and the ECU 110 may control the transmission actuator 32d to change the selected reduction ratio in accordance with the signal.

The vehicle 1 further includes various operators. Specifically, the vehicle 1 includes a drive mode selector 43. The drive mode selector 43 is one of the input interface 40. The drive mode selector 43 receives an input of an operation of selecting a drive mode from among the HEV mode, the charging mode, and the EV mode. In the present embodiment, the drive mode selector 43 is disposed on the handle 102. The drive mode selector 43 includes an operator such as a button, a lever, or a touch panel that receives an input executed by the driver's hand. The drive mode selector 43 outputs a signal indicating the selected drive mode to the ECU 110.

The vehicle 1 further includes a shift mode selector 44. The shift mode selector 44 is one of the input interface 40. The shift mode selector 44 receives an input of an operation of selecting the shift mode from the manual shift mode and the automatic shift mode. In the present embodiment, the shift mode selector 44 is disposed on the handle 102. The shift mode selector 44 includes an operator such as a button, a lever, or a touch panel that receives an input executed by the driver's hand. The shift mode selector 44 outputs a signal indicating the selected shift mode to the ECU 110.

The vehicle 1 includes various sensors. Specifically, the vehicle 1 includes a first rotation sensor 121 that detects the rotation speed of the crankshaft 21c of the internal combustion engine 21. The rotation speed correlates with the rotation velocity. The first rotation sensor 121 may be disposed on a flywheel or a crank pulley attached to an end portion of the crankshaft 21c so as to rotate integrally therewith, or on a camshaft to which rotational power of the crankshaft 21c is transmitted. The first rotation sensor 121 outputs the detection result to the ECU 110. Examples of the first rotation sensor 121 may include an electromagnetic pickup rotation sensor, an anisotropic-magneto-resistive (AMR) rotation sensor, a Hall IC rotation sensor, and a mechanical, optical, magnetic, or electromagnetic induction encoder. The rotation speed can be represented by the rotation speed per minute.

The vehicle 1 includes a second rotation sensor 122 that detects the rotation speed of the drive shaft 22a of the rotary electric machine 22. The second rotation sensor 122 outputs the detection result to the ECU 110. Examples of the second rotation sensor 122 are similar to the examples of the first rotation sensor 121.

The vehicle 1 includes a third rotation sensor 123 that detects the rotation speed of the input shaft 32a of the transmission 32. The third rotation sensor 123 outputs the detection result to the ECU 110. Examples of the third rotation sensor 123 are similar to the examples of the first rotation sensor 121.

The vehicle 1 includes a gear position sensor 124 that detects the reduction ratio selected by the transmission 32. In the present embodiment, the gear position sensor 124 is implemented to detect the reduction ratio by detecting the operation of the shift drum or the shift fork of the transmission 32. The gear position sensor 124 outputs the detection result to the ECU 110.

The vehicle 1 includes a clutch sensor 125 that detects the engagement and disengagement operation of the clutch 31. For example, the clutch sensor 125 may detect each of the engagement operation and the disengagement operation of the clutch 31. The clutch sensor 125 outputs a detection signal to the ECU 110.

The vehicle 1 includes a throttle position sensor 126 that detects the operating position of the throttle grip 41. The throttle position sensor 126 outputs a detection signal to the ECU 110. Examples of the throttle position sensor 126 are similar to the examples of the first rotation sensor 121.

The throttle grip 41 is disposed on the handle 102. The throttle grip 41 has a cylindrical shape and is rotatable about a cylindrical axis. The operating position of the throttle grip 41 is the rotational position of the throttle grip 41. The throttle grip 41 is an operator that receives an operation of the driver.

The vehicle 1 includes a wheel speed sensor 127 on the rear wheel 12. The wheel speed sensor 127 detects the rotation speed of the rear wheel 12 and outputs a detection signal to the ECU 110. Examples of the wheel speed sensor 127 are similar to the examples of the first rotation sensor 121. The wheel speed sensor 127 may be disposed on the front wheel 11 and detect the rotation speed of the front wheel 11. The wheel speed sensor 127 or the ECU 110 may detect the speed of the vehicle 1 from the rotation speed. The vehicle 1 may include a position detection sensor using a global navigation satellite system (GNSS) that detects the position of the vehicle 1 on the earth. In this case, the ECU 110 may detect the speed of the vehicle 1 based on a temporal change in position information acquired by the position detection sensor.

The vehicle 1 includes a temperature sensor 128 that detects a temperature state of the battery 109. In the present embodiment, the temperature sensor 128 is disposed between the secondary battery cells of the battery 109 and detects the temperature of the secondary battery cell. The temperature sensor 128 outputs a detection signal to the ECU 110.

The ECU 110 may include a microcomputer including one or more processors P such as a central processing unit (CPU) or a digital signal processor (DSP) and a storage device M. The ECU 110 may include a clock for clocking. The storage device M may include one or more memories, one or more storages, or both of them. Examples of the memory may include a semiconductor memory. Examples of the storage may include a semiconductor memory, a hard disk drive (HDD), and a solid state drive (SSD). Examples of the semiconductor memory may include a volatile memory such as a random access memory (RAM) and a nonvolatile memory such as a read only memory (ROM). The ECU 110 may include a processing circuit. The ECU 110 may include at least a part of the storage device M in the processing circuit.

Some or all of the functions of the ECU 110 may be implemented by the CPU executing a program recorded in the ROM using the RAM as a working memory. Some or all of the functions of the ECU 110 may be implemented by a dedicated hardware circuit such as an electronic circuit or an integrated circuit. Some or all of the functions of the ECU 110 may be implemented by a combination of the software function and the hardware circuit described above. Communication between devices mounted on the vehicle 1 such as the ECU 110, various actuators, and various sensors may be communication via an in-vehicle network such as a controller area network (CAN).

The ECU 110 controls operations of the internal combustion engine 21 and the rotary electric machine 22. The ECU 110 controls the operations of the clutch 31, the internal combustion engine 21, and the rotary electric machine 22 in accordance with the drive mode selected by the drive mode selector 43. The ECU 110 autonomously determines the drive mode based on the state of the vehicle 1 such as the operation efficiency of the internal combustion engine 21 and the rotary electric machine 22, and controls the operations of the clutch 31, the internal combustion engine 21, and the rotary electric machine 22 in accordance with the determined drive mode.

The ECU 110 controls the operation of the internal combustion engine 21 by controlling the operation of one or more internal combustion engine actuators 210 that control the driving of the internal combustion engine 21. The one or more internal combustion engine actuators 210 include at least a throttle actuator 211, a fuel injection actuator 212, and an ignition actuator 213. The throttle actuator 211 drives a throttle valve 211a that adjusts a flow rate of air flowing into the cylinder block 21b. The fuel injection actuator 212 includes a fuel injection valve that injects fuel into the cylinder block 21b. The ignition actuator 213 includes an ignition plug that ignites the air-fuel mixed gas in the cylinder block 21b.

The ECU 110 adjusts the torque output by the internal combustion engine 21 in accordance with the detection signals of the sensors included in the vehicle 1 including the detection signal of the throttle position sensor 126 indicating the operation of the throttle grip 41. For example, the ECU 110 controls the operations of the throttle actuator 211, the fuel injection actuator 212, and the ignition actuator 213 such that the internal combustion engine 21 satisfies a torque corresponding to the rotation speed of the input shaft 32a of the transmission 32, a vehicle speed, and a throttle opening degree.

The ECU 110 adjusts the torque output by the rotary electric machine 22 in accordance with the detection signals of the sensors included in the vehicle 1 including the detection signal of the throttle position sensor 126 indicating the operation of the throttle grip 41. For example, the ECU 110 controls the drive circuit 22b of the rotary electric machine 22 such that the rotary electric machine 22 satisfies a torque corresponding to the rotation speed of the input shaft 32a of the transmission 32, the vehicle speed, and the throttle opening degree.

The ECU 110 controls the operation of the transmission 32 in the automatic shift mode. For example, when the rotation speed of the internal combustion engine 21 reaches a preset rotation speed, the ECU 110 causes the transmission actuator 32d to operate the transmission 32 such that the reduction ratio selected by the transmission 32 becomes smaller. For example, when the throttle position sensor 126 detects a fully closed state of the throttle grip 41, the ECU 110 causes the transmission actuator 32d to operate the transmission 32 so that the reduction ratio of the transmission 32 becomes larger. The fully closed state of the throttle grip 41 is a state in which the throttle grip 41 is not operated.

Details of the control of the traveling drive source 20 of ECU 110 will be described. The ECU 110 determines the torque required for the traveling drive source 20 using the rotation speed of the input shaft 32a of the transmission 32, a command value of the load of the traveling drive source 20, and the reduction ratio selected by the transmission 32. The ECU 110 stores, in the storage device M, a preset relation among the rotation speed of the input shaft 32a, the command value of the load of the traveling drive source 20, and the torque required for the traveling drive source 20 for each reduction ratio selectable by the transmission 32.

The ECU 110 acquires the rotation speed of the input shaft 32a from the third rotation sensor 123 and acquires the reduction ratio selected by the transmission 32 from the gear position sensor 124. The command value of the load relates to the rotational position of the throttle grip 41 detected through the throttle position sensor 126. The ECU 110 can determine the command value of the load based on the rotational position of the throttle grip 41. The torque required for the traveling drive source 20 corresponds to the torque required by the driver of the vehicle 1. Hereinafter, the torque required for the traveling drive source 20 may be referred to as “rider required torque”. The rider required torque is one of the reference outputs.

The ECU 110 may store a preset rider required torque map in the storage device M. The rider required torque map is a list of graphs in which the torque required for the traveling drive source 20 is determined by the rotation speed of the input shaft 32a and the load of the traveling drive source 20. The rider required torque map is set for each reduction ratio selectable by the transmission 32. The ECU 110 can determine the rider required torque required for the traveling drive source 20 using the rider required torque map corresponding to the reduction ratio selected by the transmission 32, the detection result of the third rotation sensor 123, and the detection result of the throttle position sensor 126.

In the HEV mode, the rider required torque is a torque obtained by adding an engine required torque, which is a torque required for the internal combustion engine 21, and a motor required torque, which is a torque required for the rotary electric machine 22. A required torque ratio that is a ratio between the engine required torque and the motor required torque within the rider required torque is preset. The required torque ratio may be constant or may fluctuate in accordance with one or more of the rotation speed of the input shaft 32a, the reduction ratio selected by the transmission 32, and the velocity of the vehicle 1.

The internal combustion engine 21 can generate a relatively high torque in a medium-high rotation range of a rotation speed range equal to or lower than an allowable rotation speed set in the internal combustion engine 21, generates a lower torque in a low rotation range than in the medium-high rotation range, and generates a lower torque as the rotation speed decreases. The rotary electric machine 22 can generate a relatively high torque in a low rotation range of a rotation speed range equal to or lower than an allowable rotation speed set in the rotary electric machine 22, generates a lower torque in a medium-high rotation range than in the low rotation range, and generates a lower torque as the rotation speed increases.

Therefore, the required torque ratio may fluctuate such that the ratio of the engine required torque increases as the rotation speed of the input shaft 32a increases. The required torque ratio may fluctuate such that the ratio of the engine required torque increases as the reduction ratio selected by the transmission 32 decreases. The required torque ratio may fluctuate such that the ratio of the engine required torque increases as the vehicle speed increases.

In the EV mode, the rider required torque is the motor required torque required for the rotary electric machine 22. In the charging mode, the rider required torque is the engine required torque required for the internal combustion engine 21.

In any drive mode, the ECU 110 determines a target fuel injection amount to be supplied to the internal combustion engine 21 based on the rotation speed of the internal combustion engine 21 in order to cause the internal combustion engine 21 to realize the engine required torque. The ECU 110 stores, in the storage device M, a preset relation among the rotation speed of the internal combustion engine 21, a required load of the internal combustion engine 21, and the target fuel injection amount for each reduction ratio selectable by the transmission 32.

The ECU 110 determines a target current value to be applied to the rotary electric machine 22 based on the rotation speed of the rotary electric machine 22 in order to cause the rotary electric machine 22 to realize the motor required torque. The ECU 110 stores, in the storage device M, a preset relation among the rotation speed of the rotary electric machine 22, the required load of the rotary electric machine 22, and the target current value for each reduction ratio selectable by the transmission 32.

The ECU 110 may store a fuel map preset for the internal combustion engine 21 and a current map preset for the rotary electric machine 22 in the storage device M.

The fuel map is a list of graphs in which the target fuel injection amount is determined by the rotation speed of the internal combustion engine 21 and the required load of the internal combustion engine 21. The fuel map is set for each reduction ratio selectable by the transmission 32. The ratio of the required load of the internal combustion engine 21 to the command value of the load of the traveling drive source 20 corresponds to the ratio of the engine required torque to the rider required torque. The ECU 110 can determine the target fuel injection amount using the fuel map corresponding to the reduction ratio selected by the transmission 32, the detection result of the first rotation sensor 121, and the required load of the internal combustion engine 21 based on the detection result of the throttle position sensor 126.

The current map is a list of graphs in which the target current value is determined by the rotation speed of the rotary electric machine 22 and the required load of the rotary electric machine 22. The current map is set for each reduction ratio selectable by the transmission 32. The ratio of the required load of the rotary electric machine 22 to the command value of the load of the traveling drive source 20 corresponds to the ratio of the motor required torque to the rider required torque. The ECU 110 can determine the target current value using the current map corresponding to the reduction ratio selected by the transmission 32, the detection result of the second rotation sensor 122, and the required load of the rotary electric machine 22 based on the detection result of the throttle position sensor 126.

The ECU 110 is implemented to execute normal control for controlling the traveling drive source 20 to cause the vehicle 1 to travel in response to the rider required torque, and assist control for controlling the traveling drive source 20 to assist the acceleration of the vehicle 1 more than in the normal control. The ECU 110 determines whether a plurality of preset assist conditions are satisfied, and determines whether to execute the normal control or the assist control based on the determination result. In the present embodiment, the ECU 110 executes the assist control when at least two assist conditions are satisfied, and executes the normal control when less than two assist conditions are satisfied. In the assist control, the ECU 110 controls the traveling drive source 20 based on an acceleration torque increased from the rider required torque. The acceleration torque is one of assist outputs.

For example, when the vehicle 1 approaches an uphill road from a flat road while traveling, even if the driver operates the throttle grip 41, the vehicle 1 may not accelerate as expected by the driver due to a torque shortage generated by the traveling drive source 20. In such a case, the ECU 110 can compensate for the torque shortage by executing the assist control. As a result, the driver can have a driving feeling as if a kickdown in which the reduction ratio becomes larger occurs in the transmission 32 even though the reduction ratio selected by the transmission 32 is not changed.

In the present embodiment, the ECU 110 determines whether the assist conditions are satisfied in order to determine whether to start the assist control and whether to end the assist control during execution of the assist control. Further, the plurality of assist conditions used to determine the start of the assist control are different from the plurality of assist conditions used to determine the end of the assist control.

The plurality of assist conditions used by the ECU 110 include a first assist condition related to an operation for accelerating the vehicle 1, a second assist condition related to the state of the vehicle 1, and a third assist condition related to the state of the vehicle 1.

The first assist condition is that a change amount of an operation amount of the throttle grip 41 is equal to or larger than a change amount threshold Tha. The first assist condition is satisfied when the change amount of the operation amount of the throttle grip 41 is equal to or larger than the change amount threshold Tha, and is not satisfied when the change amount of the operation amount of the throttle grip 41 is less than the change amount threshold Tha.

The operation amount of the throttle grip 41 corresponds to the rotational position of the throttle grip 41 detected by the throttle position sensor 126. The operation amount corresponds to a range from a rotational position of the throttle grip 41 in the fully closed state to a current rotational position of the throttle grip 41. In the present embodiment, the operation amount of the throttle grip 41 is represented by a throttle opening degree represented by a percentage ratio. The throttle opening degree is a ratio of the operation amount of the throttle grip 41 to a range from the rotational position in the fully closed state to a rotational position in a fully opened state of the throttle grip 41. The throttle opening degree corresponding to the fully closed state of the throttle grip 41 is 0%. The throttle opening degree corresponding to the fully opened state of the throttle grip 41 is 100%. The throttle opening degree corresponding to the operation amount of the throttle grip 41 is represented by a percentage ratio corresponding to a ratio of the operation amount between 0% and 100%.

The ECU 110 acquires the change amount of the operation amount of the throttle grip 41 during a preset sampling period T every sampling period T seconds. Therefore, the ECU 110 acquires the detection result from the throttle position sensor 126 every sampling period T seconds. The ECU 110 acquires, as the change amount of the operation amount, the change amount of the throttle opening degree between the throttle opening degree x(n) when the n-th sampling period Tn elapses and the throttle opening degree x(n−1) when the (n−1)-th sampling period Tn−1 immediately before the n-th sampling period Tn elapses. n is a natural number of 2 or more. The change amount of the operation amount corresponds to the change amount of the throttle opening degree x(n) with respect to the throttle opening degree x(n−1). For example, the change amount of the operation amount may be a difference obtained by subtracting the throttle opening degree x(n−1) from the throttle opening degree x(n).

In the present embodiment, the ECU 110 performs low-pass filter processing on the throttle opening degree and uses the post-processing throttle opening degree to determine the change amount of the operation amount of the throttle grip 41. For example, the ECU 110 performs the low-pass filter processing on the pre-processing throttle opening degree, which is the throttle opening degree x(n) when the n-th sampling period Tn elapses, to acquire the post-processing throttle opening degree y(n). The sampling period Tn is the latest sampling period of the change amount determination processing.

The ECU 110 uses a post-processing throttle opening degree y(n−1) when the sampling period Tn-1 immediately before the sampling period Tn elapses to acquire the post-processing throttle opening degree y(n). Specifically, the ECU 110 acquires the post-processing throttle opening degree y(n) by the following Formula 1, where k is a filter coefficient.

$$y ( n ) = y ( n - 1 ) + \{ x ( n ) - y ( n - 1 ) \} \times k \qquad ( Formula 1 )$$

The ECU 110 acquires a difference {x(n)−y(n)} obtained by subtracting the post-processing throttle opening degree y(n) from the pre-processing throttle opening degree x(n) as the change amount of the operation amount of the throttle grip 41. Since the post-processing throttle opening degree y(n) is the throttle opening degree after passing through the low-pass filter, the post-processing throttle opening degree y(n) includes information on a signal of the throttle opening degree before the sampling period Tn. Therefore, the difference {x(n)−y(n)} can be treated as the change amount of the throttle opening degree when the sampling period Tn elapses with respect to the throttle opening degree when the sampling period Tn−1 elapses.

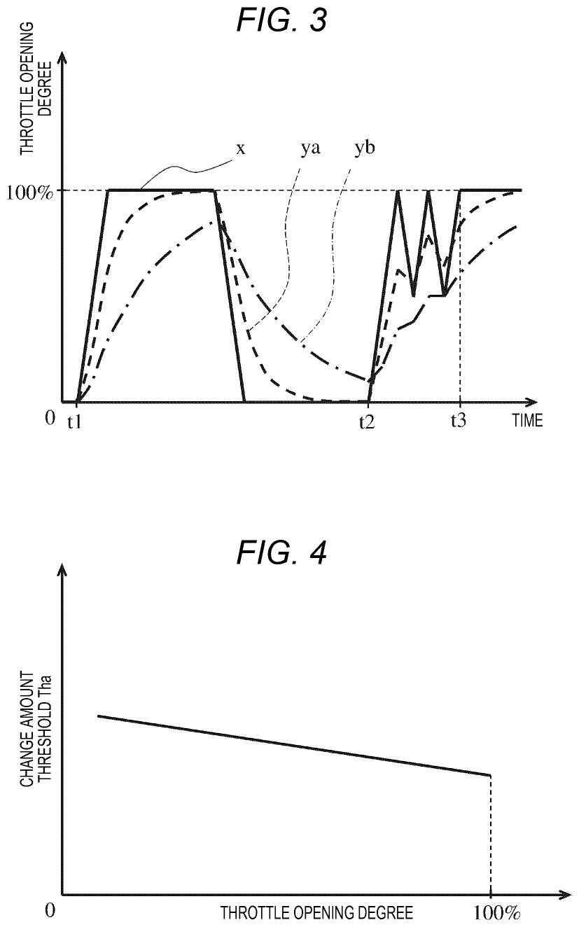

In the present embodiment, the filter coefficient is a variable and is set to a value within a range of 0 or more and 1 or less. As the filter coefficient increases, the post-processing throttle opening degree y(n) is more likely to be affected by the short-period fluctuation of the throttle opening degree. As the filter coefficient decreases, the post-processing throttle opening degree y(n) is less likely to be affected by the short-period fluctuation of the throttle opening degree. For example, as illustrated in FIG. 3, in a period from time t2 to time t3 in which the fluctuation cycle of the throttle opening degree is short, a post-processing throttle opening degree ya processed with a filter coefficient ka is more likely to be affected by a fluctuation in the pre-processing throttle opening degree x and is less likely to be affected by the low-pass filter processing than a post-processing throttle opening degree yb processed with a filter coefficient kb. The filter coefficient ka is larger than the filter coefficient kb. Meanwhile, in a period from time t1 to time t2 in which the fluctuation cycle of the throttle opening degree is long, the post-processing throttle opening degree yb is excessively affected by the low-pass filter processing. FIG. 3 is a diagram illustrating an example of a relation among the filter coefficient in the low-pass filter processing in accordance with the embodiment, the pre-processing throttle opening degree, and the post-processing throttle opening degree.

Furthermore, the absolute value of the difference {x(n)−y(n)} decreases as the filter coefficient increases. The filter coefficient may be a variable that fluctuates in accordance with the state of the vehicle 1. For example, the state of the vehicle 1 may include a combination of one or more of the fluctuation cycle of the throttle opening degree, the reduction ratio selected by the transmission 32, the velocity of the vehicle 1, the posture of the vehicle 1, and the rotation speed of the input shaft 32a. Examples of the posture of the vehicle 1 includes a bank angle that is an inclination amount of the vehicle 1 in a left-right direction.

In the present embodiment, the throttle opening degree x(n) is a throttle opening degree corresponding to the rotational position of the throttle grip 41 detected by the throttle position sensor 126 at a timing when the sampling period Tn elapses. The timing when the sampling period Tn elapses is one of second timings, and the timing when the sampling period Tn−1 elapses is one of first timings.

The throttle opening degree x(n) may be a statistical value of the throttle opening degree obtained by performing statistical processing on the detection result of the throttle position sensor 126 between the timing when the sampling period Tn elapses and the timing when the sampling period Tn−1 elapses. Examples of the statistical value may include an average value, a median value, a minimum value, a maximum value, and a mode value. The average value may include various average values.

The change amount threshold Tha fluctuates in accordance with the operation amount of the throttle grip 41. Specifically, the change amount threshold Tha fluctuates so as to decrease as the throttle opening degree increases. In the present embodiment, when comparing the change amount of the throttle opening degree when the sampling period Tn elapses with the change amount threshold Tha, the ECU 110 uses the change amount threshold Tha corresponding to the throttle opening degree x(n−1) when the sampling period Tn−1 immediately before the sampling period Tn elapses.

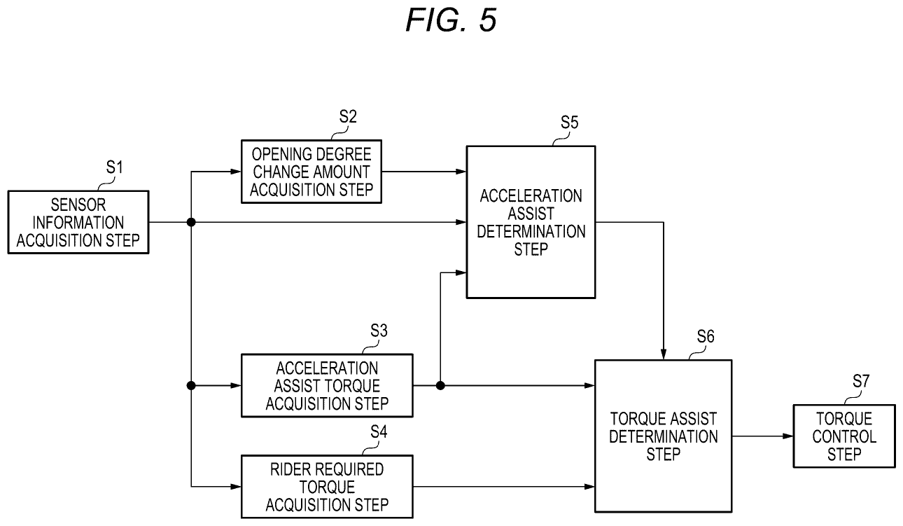

FIG. 4 is a diagram illustrating an example of a relation between the change amount threshold Tha and the throttle opening degree. As illustrated in FIG. 4, in the present embodiment, the change amount threshold Tha decreases linearly as the throttle opening degree increases. The relation between the change amount threshold Tha and the throttle opening degree is not limited to the linear function relation, and may be any function relation or non-function relation as long as the change amount threshold Tha decreases as the throttle opening degree increases.

The first assist condition is less likely to be satisfied when the throttle opening degree is small, and is not satisfied unless the driver greatly increases the throttle opening degree. As a result, in a state in which the throttle opening degree is small and the output of the traveling drive source 20 is small, the assist control is prevented from being oversensitively interposed. The first assist condition is likely to be satisfied when the throttle opening degree is large, and can be satisfied when the driver slightly increases the throttle opening degree. As a result, in a state in which the throttle opening degree is large and the output of the traveling drive source 20 is large, the assist control can be interposed in response to the driver's request.

In the present embodiment, the second assist condition includes one or more assist prohibition conditions. Therefore, when none of the assist prohibition conditions is satisfied, the second assist condition is satisfied, and when at least one assist prohibition condition is satisfied, the second assist condition is not satisfied. In the present embodiment, the second assist condition includes a first assist prohibition condition to a third assist prohibition condition.

The first assist prohibition condition is a condition where the reduction ratio selected by the transmission 32 is larger than a reduction ratio threshold Thb. The first assist prohibition condition is satisfied when the reduction ratio selected by the transmission 32 is larger than the reduction ratio threshold Thb, and the first assist prohibition condition is not satisfied when the reduction ratio selected by the transmission 32 is equal to or less than the reduction ratio threshold Thb.

For example, when six reduction ratios of a first reduction ratio to a sixth reduction ratio are selectable in the transmission 32, the first assist prohibition condition may be a condition where any one of the first reduction ratio to the (k−1)-th reduction ratio larger than the k-th reduction ratio is selected in the transmission 32. The six reduction ratios sequentially decrease from the first reduction ratio toward the sixth reduction ratio. The k-th reduction ratio is a reduction ratio closest to the reduction ratio threshold Thb among reduction ratios equal to or less than the reduction ratio threshold Thb. k is a natural number of 2 or more.

In a state in which the first assist prohibition condition is satisfied, the torque generated by the internal combustion engine 21 and the rotary electric machine 22 is relatively greatly increased and transmitted to the rear wheel 12. Therefore, the torque generated by the internal combustion engine 21 and the rotary electric machine 22 can satisfy the driver's request for acceleration of the vehicle 1 via the operation of the throttle grip 41. In a state in which the first assist prohibition condition is not satisfied, the torques generated by the internal combustion engine 21 and the rotary electric machine 22 may be insufficient for the request.

The second assist prohibition condition is a condition where the rotation speed of an input shaft, which is the input shaft 32a of the transmission 32, is equal to or larger than a rotation speed threshold Thc. The second assist prohibition condition is satisfied when the rotation speed of the input shaft 32a is equal to or larger than the rotation speed threshold Thc, and the second assist prohibition condition is not satisfied when the rotation speed of the input shaft 32a is less than the rotation speed threshold Thc. The rotation speed threshold Thc is one of first rotation speeds.

The rotation speed threshold Thc corresponds to a rotation speed at which the traveling drive source 20 can generate an effective torque. The torque generated by the internal combustion engine 21 in the low rotation range is small, and the torque generated by the rotary electric machine 22 in the low rotation range is large. Therefore, in the present embodiment, the rotation speed threshold Thc is set to a rotation speed at which the internal combustion engine 21 can generate an effective torque. Since the vehicle 1 is a motorcycle, the internal combustion engine 21 is of a high-speed rotation type. Therefore, an example of the rotation speed threshold Thc is 3000 rpm. rpm is a rotation speed per minute.

In a state in which the second assist prohibition condition is satisfied, the internal combustion engine 21 and the rotary electric machine 22 generate relatively large torques. Therefore, the torques generated by the internal combustion engine 21 and the rotary electric machine 22 can satisfy the driver's request for acceleration of the vehicle 1 via the operation of the throttle grip 41. In a state in which the second assist prohibition condition is not satisfied, the torques generated by the internal combustion engine 21 and the rotary electric machine 22 may be insufficient for the request.

The third assist prohibition condition is a condition where the shift mode being executed is not the automatic shift mode. The third assist prohibition condition is satisfied when the shift mode being executed is the manual shift mode, and the third assist prohibition condition is not satisfied when the shift mode being executed is the automatic shift mode. When the shift mode is not the automatic shift mode, the driver can change the reduction ratio selected by the transmission 32 by operating the shift operator 42. For example, when the driver feels insufficient in the acceleration of the vehicle 1, the driver can improve the acceleration of the vehicle 1 by changing the reduction ratio selected by the transmission 32 to a larger reduction ratio.

In a state in which the third assist prohibition condition is satisfied, an increase in torque implemented by the assist control may be unnecessary. In a state in which the third assist prohibition condition is not satisfied, the shift mode being executed is the automatic shift mode, and therefore, it may be necessary to increase the torque by the assist control.

The second assist condition may further include one or more of a fourth assist prohibition condition to a sixth assist prohibition condition.

The fourth assist prohibition condition is a condition where the vehicle 1 is driven only by the rotary electric machine 22. When the vehicle 1 is driven only by the rotary electric machine 22, the fourth assist prohibition condition is satisfied, and when the vehicle 1 is driven by the internal combustion engine 21 in addition to or instead of the rotary electric machine 22, the fourth assist prohibition condition is not satisfied. The torque generated by the rotary electric machine 22 is large, and a fluctuation amount of the torque remains small even when the rotation speed of the rotary electric machine 22 fluctuates. The torque generated by the internal combustion engine 21 greatly fluctuates in accordance with the fluctuation of the rotation speed of the internal combustion engine 21.

In a state in which the fourth assist prohibition condition is satisfied, even if the rotation speed of the input shaft 32a fluctuates, the rotary electric machine 22 outputs a sufficient torque, and thus the assist control may be unnecessary. In a state in which the fourth assist prohibition condition is not satisfied, the torque generated by the internal combustion engine 21 may be insufficient depending on the rotation speed of the input shaft 32a, and assist control may be required.

The fifth assist prohibition condition is a condition where the state of the clutch 31 detected by the clutch sensor is the disengaged state. The fifth assist prohibition condition is satisfied in the disengaged state of the clutch 31, and the fifth assist prohibition condition is not satisfied in the engaged state of the clutch 31. In the disengaged state of the clutch 31, only the torque generated by the rotary electric machine 22 can be transmitted to the input shaft 32a of the transmission 32. In the engaged state of the clutch 31, torques generated by the internal combustion engine 21 and the rotary electric machine 22 can be transmitted to the input shaft 32a.

In a state in which the fifth assist prohibition condition is satisfied, the vehicle 1 is driven only by the rotary electric machine 22, so that the assist control may be unnecessary as in the state in which the fourth assist prohibition condition is satisfied. In a state in which the fifth assist prohibition condition is not satisfied, the vehicle 1 can be driven by the internal combustion engine 21 in addition to or instead of the rotary electric machine 22, so that the assist control may be required as in the state in which the fourth assist prohibition condition is not satisfied.

The sixth assist prohibition condition is a condition where the temperature of the battery 109 detected by the temperature sensor 128 is equal to or higher than a temperature threshold Thd. The sixth assist prohibition condition is satisfied when the temperature of the battery 109 is equal to or higher than the temperature threshold Thd, and the sixth assist prohibition condition is not satisfied when the temperature of the battery 109 is lower than the temperature threshold Thd. During execution of the assist control, the load received by the battery 109 may increase in order to increase the torques of the internal combustion engine 21 and the rotary electric machine 22. When the battery 109 having a temperature equal to or higher than the temperature threshold Thd receives an excessive load, performance such as durability of the battery 109 may be deteriorated. The temperature threshold Thd is one of first temperatures.

In a state in which the sixth assist prohibition condition is satisfied, it is desirable to prohibit the assist control to prevent an increase in the load received by the battery 109. In a state in which the sixth assist prohibition condition is not satisfied, an increase in the load received by the battery 109 is allowed, so that the assist control can be executed.

The third assist condition includes one or more assist end conditions, and in the present embodiment, includes a first assist end condition to a fourth assist end condition. The first assist end condition is a condition where at least one of one or more assist prohibition conditions is satisfied. The first assist end condition is satisfied when at least one assist prohibition condition is satisfied, and the first assist end condition is not satisfied when all the assist prohibition conditions are not satisfied. Since it is desirable that the assist control is not executed in a state in which the assist prohibition condition is satisfied, it is desirable to end the assist control. When the first assist end condition is satisfied, the second assist condition is not satisfied.

The second assist end condition is a condition where an acceleration assist torque, which is a difference obtained by subtracting the rider required torque from the acceleration torque, is 0. The second assist end condition is satisfied when the acceleration assist torque is 0, and the second assist end condition is not satisfied when the acceleration assist torque is not 0. In a state in which the second assist end condition is satisfied, since the difference between the acceleration torque and the rider required torque is 0, it is desirable to end the assist control. The acceleration assist torque is one of additional outputs.

The third assist end condition is a condition where the throttle opening degree based on the detection result of the throttle position sensor 126 is equal to or less than a throttle threshold The. The third assist end condition is satisfied when the throttle opening degree is equal to or less than the throttle threshold The, and the third assist end condition is not satisfied when the throttle opening degree exceeds the throttle threshold The.

In the present embodiment, the throttle opening degree equal to or less than the throttle threshold The is an opening degree in the fully closed state or close to the fully closed state. For example, the throttle threshold The may be a throttle opening degree less than 10%. Further, the throttle threshold The may be a throttle opening degree corresponding to an idling state of the internal combustion engine 21. In a state in which the third assist end condition is satisfied, it can be considered that the driver does not require the acceleration of the vehicle 1 through the operation of the throttle grip 41, and thus it is desirable to end the assist control. The throttle threshold The is one of first operation amounts.

The fourth assist end condition is a condition where the reduction ratio selected by the transmission 32, which is detected by the gear position sensor 124, is changed. The fourth assist end condition is satisfied when the reduction ratio selected by the transmission 32 is changed, and the fourth assist end condition is not satisfied when the reduction ratio selected by the transmission 32 is not changed.

For example, when the reduction ratio selected by the transmission 32 is changed to a larger reduction ratio, the torque transmitted from the internal combustion engine 21 and the rotary electric machine 22 to the rear wheel 12 increases, so that the assist control may be unnecessary. When the reduction ratio selected by the transmission 32 is changed to a smaller reduction ratio, the ECU 110 needs to determine a new acceleration torque, and thus ends the assist control being executed. In a state in which the fourth assist end condition is satisfied, it is desirable that the ECU 110 ends the assist control being executed in order to newly determine an acceleration assist torque that is a difference between the acceleration torque and the rider required torque.

In the present embodiment, when determining that the first assist condition is satisfied and the second assist condition is satisfied, the ECU 110 ends the normal control and starts the assist control. When the second assist condition is satisfied, none of the assist prohibition conditions set as the second assist condition is satisfied. When the second assist condition is not satisfied, at least one of the assist prohibition conditions set as the second assist condition is satisfied.

In the present embodiment, when the second assist condition is satisfied, none of the first assist prohibition condition to third assist prohibition condition is satisfied. Therefore, the ECU 110 can execute the assist control in the HEV mode and the charging mode.

The rider required torque can be distributed to the engine required torque and the motor required torque in accordance with the required torque ratio. The acceleration torque can also be distributed to an engine acceleration torque and a motor acceleration torque. The engine acceleration torque and the motor acceleration torque may be distributed from the acceleration torque in accordance with the required torque ratio. The engine acceleration torque is a target torque of the internal combustion engine 21 increased from the engine required torque, and the motor acceleration torque is a target torque of the rotary electric machine 22 increased from the motor required torque.

When the assist control is started, the ECU 110 increases the torque of the internal combustion engine 21 from the engine required torque to the engine acceleration torque, and increases the torque of the rotary electric machine 22 from the motor required torque to the motor acceleration torque. In the present embodiment, the ECU 110 executes tailing processing of gradually increasing the torque of each of the internal combustion engine 21 and the rotary electric machine 22.

For example, the ECU 110 gradually increases the torque of the internal combustion engine 21 to the engine acceleration torque and gradually increases the torque of the rotary electric machine 22 to the motor acceleration torque over a first tailing time which is a preset time. The first tailing time is longer than the sampling period T.

Alternatively, the ECU 110 increases the torque of the internal combustion engine 21 to the engine acceleration torque at a preset first increasing velocity, and increases the torque of the rotary electric machine 22 to the motor acceleration torque at a preset second increasing velocity. The first increasing velocity and the second increasing velocity are torque increasing velocities, and can be represented by torque values that increase per second. The first increasing velocity and the second increasing velocity may be the same as or different from each other. The time required for increasing the engine required torque to the engine acceleration torque at the first increasing velocity and the time required for increasing the motor required torque to the motor acceleration torque at the second increasing velocity are both longer than the sampling period T. The first increasing velocity and the second increasing velocity are each a first velocity.

In the present embodiment, since the ECU 110 determines the acceleration torque every sampling period T, the engine acceleration torque and the motor acceleration torque may fluctuate every sampling period T. The ECU 110 increases the torques of the internal combustion engine 21 and the rotary electric machine 22 with the engine acceleration torque and the motor acceleration torque determined for each sampling period T as target torques.

In the present embodiment, when determining that the third assist condition is satisfied during execution of the assist control, the ECU 110 ends the assist control and shifts to the normal control. When the third assist condition is satisfied, at least one of the assist end conditions set as the third assist condition is satisfied. When the third assist condition is not satisfied, none of the assist end conditions set as the third assist condition is satisfied. When the third assist condition is satisfied, the first assist end condition may be satisfied, that is, the second assist condition may not be satisfied.

When ending the assist control, the ECU 110 decreases the torque of the internal combustion engine 21 from a current state to the engine required torque and decreases the torque of the rotary electric machine 22 from a current state to the motor required torque. In the present embodiment, the ECU 110 executes tailing processing of gradually decreasing the torque of each of the internal combustion engine 21 and the rotary electric machine 22.

For example, the ECU 110 gradually decreases the torque of the internal combustion engine 21 to the engine required torque and gradually decreases the torque of the rotary electric machine 22 to the motor required torque over a second tailing time which is a preset time. In the present embodiment, the second tailing time is longer than the first tailing time.

Alternatively, the ECU 110 decreases the torque of the internal combustion engine 21 to the engine required torque at a preset first decreasing velocity, and decreases the torque of the rotary electric machine 22 to the motor required torque at a preset second decreasing velocity. The first decreasing velocity and the second decreasing velocity are decreasing velocities of the torque, and can be represented by torque values that decrease per second. The first decreasing velocity and the second decreasing velocity may be the same as or different from each other. The absolute value of the first decreasing velocity is smaller than the absolute value of the first increasing velocity, and the absolute value of the second decreasing velocity is smaller than the absolute value of the second increasing velocity. The time required for decreasing the current state to the engine required torque at the first decreasing velocity is longer than the time required for increasing the engine required torque to the engine acceleration torque at the first increasing velocity, and the time required for decreasing the current state to the motor required torque at the second decreasing velocity is longer than the time required for increasing the motor required torque to the motor acceleration torque at the second increasing velocity. The first decreasing velocity and the second decreasing velocity are each a second velocity.

In the present embodiment, since the ECU 110 determines the motor required torque every sampling period T, the engine required torque and the motor required torque may fluctuate every sampling period T. The ECU 110 decreases the torques of the internal combustion engine 21 and the rotary electric machine 22 with the engine required torque and the motor required torque determined for each sampling period T as target torques.

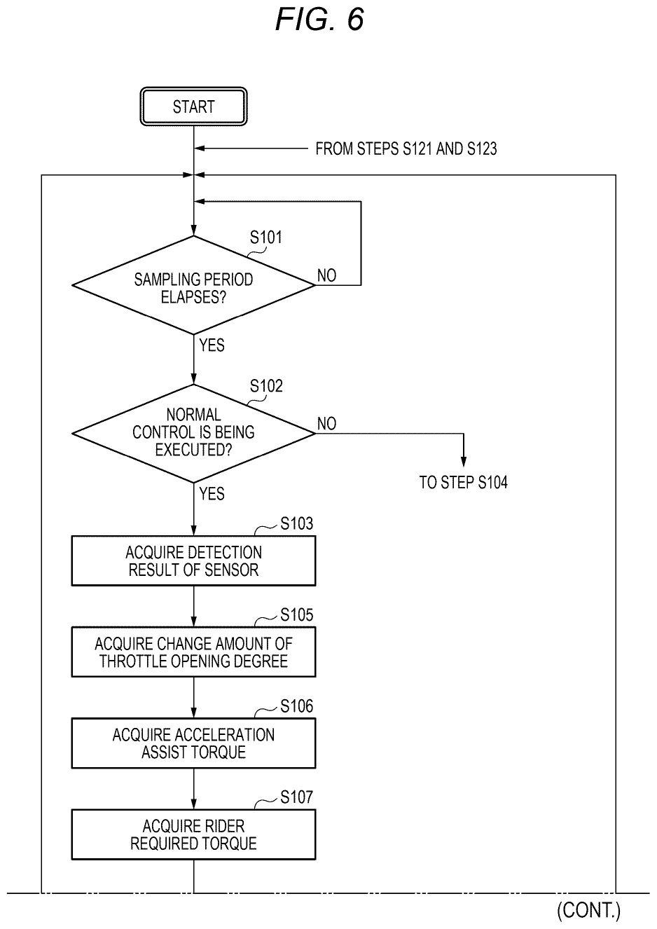

Control steps related to the assist control of the ECU 110 according to the embodiment will be described. FIG. 5 is a diagram illustrating an example of the control steps related to the assist control of the ECU 110 according to the embodiment. The control steps in the HEV mode will be described below. In the charging mode, processing related to the rotary electric machine 22 is omitted.

As illustrated in FIG. 5, in a sensor information acquisition step S1, the ECU 110 acquires detection results from various sensors for each sampling period T. For example, the ECU 110 acquires detection results when the n-th sampling period Tn elapses. The ECU 110 acquires at least the rotation speed of the input shaft 32a of the transmission 32 detected by the third rotation sensor 123, the reduction ratio selected by the transmission 32 detected by the gear position sensor 124, and the throttle opening degree detected by the throttle position sensor 126.

In an opening degree change amount acquisition step S2, the ECU 110 acquires the change amount of the throttle opening degree between the throttle opening degree x(n) when the sampling period Tn elapses and the throttle opening degree x(n−1) when the (n−1)-th sampling period Tn−1 elapses. The ECU 110 may perform low-pass filter processing on the throttle opening degree and acquire the change amount of the throttle opening degree using the post-processing throttle opening degree.

In an acceleration assist torque acquisition step S3, the ECU 110 acquires the value of the acceleration assist torque to be added to the value of the rider required torque of the traveling drive source 20 in order to obtain the value of the acceleration torque of the traveling drive source 20. For example, the ECU 110 calculates the value of the acceleration assist torque using the rotation speed of the input shaft 32a of the transmission 32, the reduction ratio selected by the transmission 32, and the throttle opening degree. The rotation speed of the input shaft 32a, the reduction ratio, and the throttle opening degree are detection results when the sampling period Tn elapses. The ECU 110 stores, in the storage device M, a preset relation among the rotation speed of the input shaft 32a, the throttle opening degree, and the acceleration assist torque for each reduction ratio selectable by the transmission 32.

For example, the relation regarding the acceleration assist torque is set for each reduction ratio equal to or less than the reduction ratio threshold Thb among the reduction ratios selectable by the transmission 32. The relation regarding the acceleration assist torque at each reduction ratio may be set within a range equal to or larger than a rotation speed Ra, which is a preset range of the rotation speed of the input shaft 32a, and less than the rotation speed threshold Thc. The range of the rotation speed may be the same or different among a plurality of reduction ratios. The relation regarding the acceleration assist torque at each reduction ratio may be set within a range of Ta% or more and 100% or less, which is a preset range of the throttle opening degree. The range of the throttle opening degree may be the same or different among the plurality of reduction ratios.

In the present embodiment, at each reduction ratio, the acceleration assist torque is set to increase as the throttle opening degree increases. Further, at each reduction ratio, the acceleration assist torque is set to increase as the rotation speed of the input shaft 32a increases. For example, the acceleration assist torque may be set as a torque that increases the rider required torque, which corresponds to the rotation speed of the input shaft 32a, the reduction ratio selected by the transmission 32, and the throttle opening degree, by a preset ratio. The increase rate may fluctuate in accordance with one or more of the rotation speed of the input shaft 32a, the reduction ratio selected by the transmission 32, and the throttle opening degree, or may be a fixed value.

The ECU 110 may store a preset acceleration assist torque map in the storage device M. The acceleration assist torque map is a list of graphs in which the acceleration assist torque is determined by the rotation speed of the input shaft 32a and the throttle opening degree. The acceleration assist torque map is set for each reduction ratio selectable by the transmission 32. The ECU 110 can determine the value of the acceleration assist torque using the acceleration assist torque map corresponding to the reduction ratio selected by the transmission 32, the rotation speed of the input shaft 32a, and the throttle opening degree.

In a rider required torque acquisition step S4, the ECU 110 acquires the value of the rider required torque of the traveling drive source 20. For example, the ECU 110 calculates the value of the rider required torque using the rotation speed of the input shaft 32a of the transmission 32, the reduction ratio selected by the transmission 32, and the throttle opening degree. The rotation speed of the input shaft 32a, the reduction ratio, and the throttle opening degree are detection results when the sampling period Tn elapses. The ECU 110 stores, in the storage device M, a preset relation among the rotation speed of the input shaft 32a, the throttle opening degree, and the rider required torque for each reduction ratio selectable by the transmission 32.

The ECU 110 may store the rider required torque map in the storage device M and use the rider required torque map for calculating the rider required torque. The ECU 110 can determine the value of the rider required torque using the rider required torque map corresponding to the reduction ratio selected by the transmission 32, the rotation speed of the input shaft 32a, and the throttle opening degree.

In an acceleration assist determination step S5, the ECU 110 determines whether to execute the assist control. When the normal control is being executed, the ECU 110 determines whether to start the assist control. If the assist control is being executed, the ECU 110 determines whether to end the assist control.

When determining whether to start the assist control, the ECU 110 determines whether both the first assist condition where the change amount of the throttle opening degree is equal to or larger than the change amount threshold Tha and the second assist condition are satisfied.

When determining that both the first assist condition and the second assist condition are satisfied, the ECU 110 determines to start the assist control. When the second assist condition is satisfied, none of the assist prohibition conditions included in the second assist condition is satisfied.

When determining that the first assist condition or the second assist condition is not satisfied, the ECU 110 determines to continue the normal control. When the second assist condition is not satisfied, any of the assist prohibition conditions included in the second assist condition is satisfied.

When determining whether to end the assist control, the ECU 110 determines whether the third assist condition is satisfied. When determining that the third assist condition is satisfied, the ECU 110 determines to end the assist control. When the third assist condition is satisfied, any of the assist end conditions included in the third assist condition is satisfied.

When determining that the third assist condition is not satisfied, the ECU 110 determines to continue the assist control. When the third assist condition is not satisfied, none of the assist end conditions included in the third assist condition is satisfied.

In a torque assist determination step S6, the ECU 110 determines values of torques to be generated by the internal combustion engine 21 and the rotary electric machine 22. For example, in the assist control, the ECU 110 calculates the value of the acceleration torque by adding the value of the acceleration assist torque to the value of the rider required torque. The ECU 110 determines the value of the engine acceleration torque and the value of the motor acceleration torque by distributing the acceleration torque. The ECU 110 may determine the value of the engine acceleration torque and the value of the motor acceleration torque by adding the value of an engine assist torque and the value of a motor assist torque obtained by distributing the acceleration assist torque to the value of the engine required torque and the value of the motor required torque obtained by distributing the rider required torque, respectively. The engine assist torque and the motor assist torque may be distributed from the acceleration assist torque in accordance with the required torque ratio.

In the normal control, the ECU 110 determines the value of the engine required torque and the value of the motor required torque by distributing the rider required torque.

In a torque control step S7, the ECU 110 controls the torques to be generated by the internal combustion engine 21 and the rotary electric machine 22. In the assist control, the ECU 110 causes the internal combustion engine 21 and the rotary electric machine 22 to generate the engine acceleration torque and the motor acceleration torque, respectively. In the normal control, the ECU 110 causes the internal combustion engine 21 and the rotary electric machine 22 to generate the engine required torque and the motor required torque, respectively.

The ECU 110 repeats step S1 to step S7 for each sampling period T. The ECU 110 may perform tailing processing when increasing and decreasing the torques generated by the internal combustion engine 21 and the rotary electric machine 22. The ECU 110 may perform the tailing processing such that the torque fluctuation over time is gentler in the decrease of the torque than in the increase of the torque.

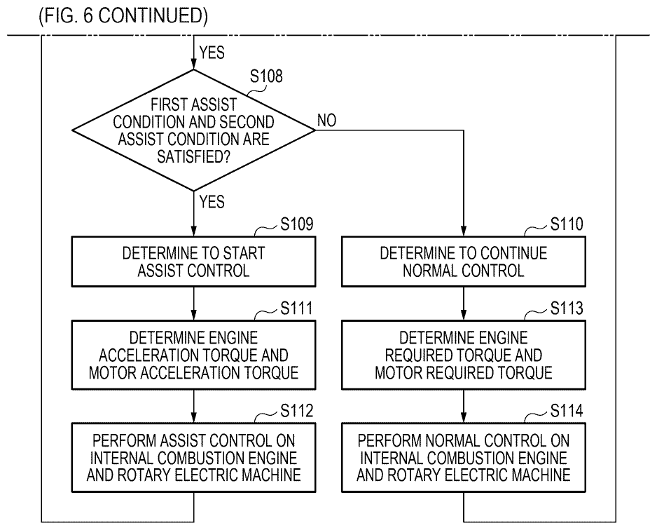

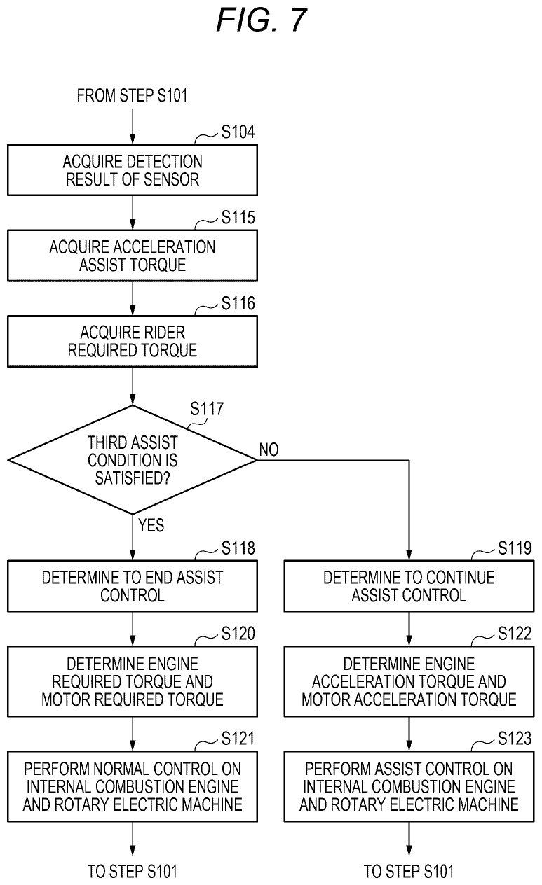

An example of the flow of the operation of the ECU 110 according to the embodiment will be described. FIGS. 6 and 7 are each a flowchart illustrating the example of the flow of the operation of the ECU 110 according to the embodiment. The operation of the ECU 110 in the HEV mode will be described below. In the charging mode, operations related to the rotary electric machine 22 are omitted.

As illustrated in FIGS. 6 and 7, in step S101, the ECU 110 determines whether the timing at which the sampling period T elapses has been reached. The ECU 110 proceeds to step S102 when the timing at which the sampling period T elapses has been reached (Yes in step S101), and repeats step S101 when the timing at which the sampling period T elapses has not been reached (No in step S101).

Next, in step S102, the ECU 110 proceeds to step S103 when the control being executed is the normal control (Yes in step S102), and proceeds to step S104 when the control being executed is the assist control (No in step S102).

In step S103, the ECU 110 acquires detection results of various sensors including a detection result related to the determination of the start of the assist control.

Next, in step S105, the ECU 110 acquires the change amount of the throttle opening degree. The change amount of the throttle opening degree is obtained based on the throttle opening degree when the sampling period T elapses and the throttle opening degree when the sampling period immediately before the sampling period T elapses.

Next, in step S106, the ECU 110 acquires the value of the acceleration assist torque.

Next, in step S107, the ECU 110 acquires the value of the rider required torque.

Next, in step S108, the ECU 110 determines whether the first assist condition and the second assist condition are satisfied. The ECU 110 proceeds to step S109 when the first assist condition and the second assist condition are satisfied (Yes in step S108), and proceeds to step S110 when the first assist condition or the second assist condition is not satisfied (No in step S108).

In step S109, the ECU 110 determines to start the assist control, and proceeds to step S111.

In step S110, the ECU 110 determines to continue the normal control, and proceeds to step S113.

In step S111, the ECU 110 determines the value of the acceleration torque based on the acceleration assist torque and the rider required torque. Further, the ECU 110 determines the value of the engine acceleration torque and the value of the motor acceleration torque based on the acceleration torque.

Next, in step S112, the ECU 110 performs the assist control on the internal combustion engine 21 and the rotary electric machine 22 so as to generate the engine acceleration torque and the motor acceleration torque. After step S112, the ECU 110 proceeds to step S101.

In step S113, the ECU 110 determines the value of the engine required torque and the value of the motor required torque based on the rider required torque.

Next, in step S114, the ECU 110 performs the normal control on the internal combustion engine 21 and the rotary electric machine 22 so as to generate the engine required torque and the motor required torque. After step S114, the ECU 110 proceeds to step S101.

In step S104, the ECU 110 acquires detection results of various sensors including a detection result related to the determination of the end of the assist control.

Next, in step S115, the ECU 110 acquires the value of the acceleration assist torque.

Next, in step S116, the ECU 110 acquires the value of the rider required torque.

Next, in step S117, the ECU 110 determines whether the third assist condition is satisfied. The ECU 110 proceeds to step S118 when the third assist condition is satisfied (Yes in step S117), and proceeds to step S119 when the third assist condition is not satisfied (No in step S117).

In step S118, the ECU 110 determines to end the assist control, and proceeds to step S120.

In step S119, the ECU 110 determines to continue the assist control, and proceeds to step S122.

In step S120, the ECU 110 determines the engine required torque and the motor required torque based on the rider required torque.

Next, in step S121, the ECU 110 performs the normal control on the internal combustion engine 21 and the rotary electric machine 22 so as to generate the engine required torque and the motor required torque. After step S121, the ECU 110 proceeds to step S101.

In step S122, the ECU 110 determines the acceleration torque based on the acceleration assist torque and the rider required torque. Further, the ECU 110 determines the engine acceleration torque and the motor acceleration torque based on the acceleration torque.

Next, in step S123, the ECU 110 performs the assist control on the internal combustion engine 21 and the rotary electric machine 22 so as to generate the engine acceleration torque and the motor acceleration torque. After step S123, the ECU 110 proceeds to step S101.

Through step S101 to step S123, the ECU 110 determines whether to execute the assist control or the normal control for each sampling period T, and controls the internal combustion engine 21 and the rotary electric machine 22 in accordance with the determined control.

### Others

Although the exemplary embodiment of the present disclosure have been described above, the present disclosure is not limited to the embodiment described above. That is, various modifications and improvements can be made within the scope of the present disclosure. For example, various modifications to the embodiment and forms constructed by combining components in different embodiments are also included in the scope of the present disclosure.

For example, in the assist control in the HEV mode, the ECU 110 according to the embodiment distributes the acceleration assist torque to the engine assist torque of the internal combustion engine 21 and the motor assist torque of the rotary electric machine 22 to increase the torques of both the internal combustion engine 21 and the rotary electric machine 22, but the control of the ECU 110 is not limited thereto. For example, the ECU 110 may apply the acceleration assist torque to either the internal combustion engine 21 or the rotary electric machine 22 to increase the torque of the internal combustion engine 21 or the rotary electric machine 22. The ECU 110 may apply the acceleration assist torque only to the internal combustion engine 21 in the assist control in the charging mode.

The ECU 110 according to the embodiment is implemented not to perform the assist control in the EV mode, but the configuration of the ECU 110 is not limited thereto. The ECU 110 may be implemented to perform the assist control in the EV mode. The ECU 110 may apply the acceleration assist torque only to the rotary electric machine 22 in the assist control in the EV mode.

The ECU 110 according to the embodiment acquires the acceleration assist torque for each sampling period T regardless of whether the assist control or the normal control is being executed, but the control of the ECU 110 is not limited thereto. For example, the ECU 110 may acquire the acceleration assist torque when determining to continue the assist control during execution of the assist control. The ECU 110 may acquire the acceleration assist torque when determining to start the assist control during execution of the normal control.

In the assist control, the ECU 110 according to the embodiment determines the acceleration assist torque by using the preset relation among the rotation speed of the input shaft 32a, the throttle opening degree, and the acceleration assist torque or the acceleration assist torque map for each reduction ratio selectable by the transmission 32, but the control of the ECU 110 is not limited thereto. For example, the ECU 110 may determine a torque of a preset ratio of the rider required torque as the acceleration assist torque. That is, the acceleration torque may be a torque obtained by increasing the rider required torque by a preset ratio. The ratio may be set for each reduction ratio selectable by the transmission 32. The ratio may be the same or different among the plurality of reduction ratios.

In the embodiment, the second assist condition includes the first assist prohibition condition to the third assist prohibition condition, or includes the first assist prohibition condition to the third assist prohibition condition and one or more of the fourth assist prohibition condition to the sixth assist prohibition condition, but the second assist condition is not limited thereto. The second assist condition may include one or more of the first assist prohibition condition to the third assist prohibition condition, or may include one or more of the first assist prohibition condition to the sixth assist prohibition condition.

In the embodiment, the third assist condition includes the first assist end condition to the fourth assist end condition, but the third assist condition is not limited thereto. For example, the third assist condition may include one or more of the first assist end condition to the fourth assist end condition.

In the embodiment, the change amount threshold Tha is set to fluctuate in accordance with the throttle opening degree regardless of the state of the vehicle 1, but the setting of the change amount threshold Tha is not limited thereto. The change amount threshold Tha may be set such that the relation between the throttle opening degree and the change amount threshold changes in accordance with the state of the vehicle 1. That is, the change amount threshold Tha may be set for each state of the vehicle 1. For example, the state of the vehicle 1 may include a combination of one or more of the reduction ratio selected by the transmission 32, the velocity of the vehicle 1, the posture of the vehicle 1, and the rotation speed of the input shaft 32a. Examples of the posture of the vehicle 1 includes the bank angle that is the inclination amount of the vehicle 1 in the left-right direction.

The vehicle 1 according to the embodiment is a hybrid vehicle, but may be a non-hybrid vehicle not including the rotary electric machine 22 or an EV not including the internal combustion engine 21. When the vehicle 1 is a non-hybrid vehicle, the ECU 110 may apply the acceleration assist torque to the internal combustion engine 21 in the assist control. When the vehicle 1 is an EV, the ECU 110 may apply the acceleration assist torque to the rotary electric machine 22 in the assist control.

The vehicle 1 according to the embodiment is a straddle-type vehicle, but may be a scooter-type vehicle having a footrest in front of the seat. Regardless of the type of the vehicle 1, the traveling drive source 20 may be disposed between the seat 107 and the front wheel 11, or may be disposed at another position. For example, the traveling drive source 20 may have an arrangement structure that swings together with a swing arm, as can be seen well in scooter-type vehicles.

The structure of the internal combustion engine 21 mounted on the vehicle 1 according to the embodiment may be any existing structure. For example, the number of cylinders of the internal combustion engine 21 may be either a single cylinder or a multi-cylinder. The internal combustion engine 21 may be either a four-stroke engine or a two-stroke engine. The fuel used by the internal combustion engine 21 may be any fuel, such as fuels containing hydrocarbon compounds such as gasoline, ethanol, propane gas, and methane, fuels derived from plants and animals such as biofuels, or non-carbonated fuels such as hydrogen.

The vehicle 1 according to the embodiment has a structure in which the clutch lever 31b mechanically operates the clutch 31 by the driver's operation and the shift operator 42 mechanically operates the transmission 32 by the driver's operation at the time of shifting in the manual shift mode, but the structure of the vehicle 1 is not limited thereto. For example, the vehicle 1 may not include the clutch lever 31b. A shift operator 32e may be electrically connected to the transmission actuator 32d and transmit a signal indicating the designated reduction ratio input by the driver to the clutch actuator 31a and the transmission actuator 32d. The clutch actuator 31a and the transmission actuator 32d may operate the clutch 31 and the transmission 32 in accordance with the received signal to change the reduction ratio selected by the transmission 32 to the designated reduction ratio.

The vehicle 1 according to the embodiment includes the automatic transmission structure, but the structure of the vehicle 1 is not limited thereto. For example, the vehicle 1 may include only the manual shift structure described in the embodiment. Even in such a case, the ECU 110 can start the assist control based on the first assist condition and the second assist condition and end the assist control based on the third assist condition. Similarly, the ECU 110 according to the embodiment may be implemented to perform the assist control in the manual shift mode.

Each aspect example of the technique of the present disclosure is as follows. A vehicle according to a first aspect of the present disclosure includes: a wheel; a traveling drive source configured to drive the wheel; a first input interface configured to receive an input of an operation for accelerating the vehicle; and a control circuitry configured to control the traveling drive source based on an operation amount input to the first input interface, in which the control circuitry is configured to determine a reference output that is an output of the traveling drive source based on the operation amount, determine whether at least two preset assist conditions are satisfied, execute assist control to control the traveling drive source based on an assist output increased from the reference output when at least two of the assist conditions are satisfied, and execute normal control to control the traveling drive source based on the reference output when the number of the satisfied assist conditions is less than two.

According to the first aspect, the control circuitry executes the assist control or the normal control depending on whether at least two assist conditions are satisfied. The control circuitry can accelerate the vehicle more than under the normal control by executing the assist control. The timing of execution of the assist control depends on at least two assist conditions. Therefore, new assist control is achieved.

A vehicle according to a second aspect of the present disclosure may be implemented such that in the first aspect, the at least two assist conditions include a first assist condition related to an operation for accelerating the vehicle and a second assist condition related to a state of the vehicle.

According to the second aspect, the timing of execution of the assist control may depend not only on the operation of accelerating the vehicle but also on the state of the vehicle. Therefore, new assist control executed at a suitable timing is achieved.

A vehicle according to a third aspect of the present disclosure may be implemented such that in the second aspect, the control circuitry is configured to execute the assist control when the first assist condition and the second assist condition are satisfied.

According to the third aspect, the control circuitry executes the assist control when both the first assist condition related to the operation for accelerating the vehicle and the second assist condition related to the state of the vehicle are satisfied. Therefore, the assist control can be executed at a suitable timing.

A vehicle according to a fourth aspect of the present disclosure may be implemented such that in any one of the first aspect to the third aspect, the at least two assist conditions include a condition where a change amount of the operation amount is equal to or larger than a threshold that fluctuates in accordance with the operation amount.

According to the fourth aspect, the timing of execution of the assist control depends on the change amount of the operation amount and the threshold that fluctuates in accordance with the operation amount. That is, the execution timing of the assist control depends on the fluctuating operation amount. Therefore, new assist control is achieved. The first assist condition may include a condition where the change amount of the operation amount is equal to or larger than a threshold that fluctuates in accordance with the operation amount.

A vehicle according to a fifth aspect of the present disclosure may be implemented such that in the fourth aspect, the threshold fluctuates so as to decrease as the operation amount increases.

According to the fifth aspect, as the operation amount increases, the threshold decreases and the change amount of the operation amount is likely to be equal to or larger than the threshold. That is, the assist control is more likely to be executed as the operation amount increases. As a result, in the low rotation range of the traveling drive source, deterioration of the driving feeling of the driver due to the vehicle accelerating oversensitively in response to an increase in the operation amount is prevented. In the high rotation range of the traveling drive source, the vehicle accelerates quickly in response to the driver's request for acceleration, thereby improving the driver's driving feeling.

A vehicle according to a sixth aspect of the present disclosure may be implemented such that in the fourth aspect or the fifth aspect, the change amount of the operation amount is a change amount of the operation amount at a second timing that is later than a first timing with respect to the operation amount at the first timing, and the threshold corresponds to the operation amount at the first timing.

According to the sixth aspect, the control circuitry determines whether to execute the assist control based on the threshold corresponding to the operation amount at the first timing and the change amount of the operation amount immediately after the first timing. For example, when the operation amount at the first timing is small, the control circuitry does not execute the assist control unless the change amount of the operation amount immediately after the first timing is large. When the operation amount at the first timing is large, the control circuitry executes the assist control even if the change amount of the operation amount immediately after the first timing is small. Therefore, the assist control appropriately corresponding to the change in the operation amount is implemented.

A vehicle according to a seventh aspect of the present disclosure may be implemented such that in any one of the first aspect to the sixth aspect, the traveling drive source includes an internal combustion engine and a rotary electric machine, and the control circuitry is configured to increase outputs of both the internal combustion engine and the rotary electric machine from the respective reference outputs of the internal combustion engine and the rotary electric machine in the assist control.

In the seventh aspect, the relation between the rotation speed and the output in the internal combustion engine is different from the relation between the rotation speed and the output in the rotary electric machine. In the assist control, since the outputs of both the internal combustion engine and the rotary electric machine are increased, a desired assist output is obtained at various rotation speeds.

A vehicle according to an eighth aspect of the present disclosure may be implemented such that in any one of the first aspect to the seventh aspect, the vehicle further includes a transmission configured to transmit power generated by the traveling drive source to the wheel, in which the control circuitry is configured to determine an additional output based on a reduction ratio selected by the transmission, the operation amount, and a rotation speed of the traveling drive source, and determine the assist output by adding the additional output to the reference output.

According to the eighth aspect, for example, as the reduction ratio selected by the transmission is lower, the load received by the traveling drive source is larger, and thus the torque generated by the traveling drive source is less likely to accelerate the vehicle. The torque generated by the traveling drive source depends on the operation amount and the rotation speed of the traveling drive source. Therefore, the assist output corresponding to the state of the vehicle is obtained by determining the additional output based on the reduction ratio selected by the transmission, the operation amount, and the rotation speed of the traveling drive source.

A vehicle according to a ninth aspect of the present disclosure may be implemented such that in the eighth aspect, the control circuitry is configured to cancel the assist control when the determined additional output is 0 during execution of the assist control.

According to the ninth aspect, when the additional output is 0, the assist output does not increase from the reference output, and thus the assist control is unnecessary. Therefore, when the additional output is 0, the control circuitry can cancel the assist control and shift to, for example, the normal control.

A vehicle according to a tenth aspect of the present disclosure may be implemented such that in any one of the first aspect to the ninth aspect, the vehicle further includes a transmission configured to transmit power generated by the traveling drive source to the wheel, in which the at least two assist conditions include a condition where a reduction ratio selected by the transmission is equal to or less than a preset reduction ratio.

In the tenth aspect, the torque generated by the traveling drive source is less likely to accelerate the vehicle as the reduction ratio selected by the transmission is lower. The control circuitry can effectively assist the acceleration of the vehicle by executing the assist control when the reduction ratio selected by the transmission is equal to or less than a preset reduction ratio. The second assist condition may include a condition where the reduction ratio selected by the transmission is equal to or less than the preset reduction ratio.

A vehicle according to an eleventh aspect of the present disclosure may be implemented such that in any one of the first aspect to the tenth aspect, the traveling drive source includes an internal combustion engine and a rotary electric machine, the vehicle further includes a drive structure connected to the internal combustion engine and the rotary electric machine such that power generated by the internal combustion engine and the rotary electric machine is transmitted and configured to transmit the power applied from the internal combustion engine and the rotary electric machine to the wheel, the drive structure includes an input shaft to which the power generated by the internal combustion engine and the rotary electric machine is transmitted, and the at least two assist conditions include a condition where a rotation speed of the input shaft is less than a preset first rotation speed.

In the eleventh aspect, when the rotation speed of the input shaft is less than the first rotation speed, the rotation speed of the internal combustion engine is also less than the first rotation speed. Since the torque generated by the internal combustion engine at such a rotation speed may be small, the assist output is required for the traveling drive source. Therefore, the control circuitry can execute the assist control in accordance with the state of the traveling drive source. The second assist condition may include a condition where the rotation speed of the input shaft is less than the preset first rotation speed.

A vehicle according to a twelfth aspect of the present disclosure may be implemented such that in any one of the first aspect to the eleventh aspect, the traveling drive source includes an internal combustion engine and a rotary electric machine, the vehicle further includes a drive structure connected to the internal combustion engine and the rotary electric machine such that power generated by the internal combustion engine and the rotary electric machine is transmitted and configured to transmit the power applied from the internal combustion engine and the rotary electric machine to the wheel, and the at least two assist conditions include a condition where the drive structure is in a state of transmitting the power generated by the internal combustion engine to the wheel.

In the twelfth aspect, the torque that is the power generated by the internal combustion engine greatly fluctuates in accordance with the rotation speed of the internal combustion engine. The control circuitry can assist, by the assist control, the torque of the internal combustion engine that greatly fluctuates in accordance with the rotation speed. The second assist condition may include a condition where the drive structure is in a state of transmitting the power generated by the internal combustion engine to the wheel.

A vehicle according to a thirteenth aspect of the present disclosure may be implemented such that in any one of the first aspect to the twelfth aspect, the traveling drive source includes an internal combustion engine and a rotary electric machine, the vehicle further includes a battery electrically connected to the rotary electric machine; and a temperature sensor configured to detect a temperature of the battery, and the at least two assist conditions include a condition where the temperature of the battery detected by the temperature sensor is equal to or lower than a preset first temperature.

In the thirteenth aspect, when the assist control is executed, the temperature of the battery may increase. Since the assist control is executed in a state in which the temperature of the battery is equal to or lower than the first temperature, an excessive increase in the temperature of the battery is prevented. Accordingly, a decrease in durability of the battery is prevented. The second assist condition may include a condition where the temperature of the battery is equal to or lower than the preset first temperature.

A vehicle according to a fourteenth aspect of the present disclosure may be implemented such that in any one of the first aspect to the thirteenth aspect, the vehicle further includes: a transmission configured to transmit power generated by the traveling drive source to the wheel; a second input interface configured to receive an input of an operation for designating a reduction ratio selected by the transmission; and a transmission actuator configured to change the reduction ratio selected by the transmission, in which the control circuitry is configured to selectively execute control in a manual shift mode and an automatic shift mode, control the transmission actuator regardless of the operation input to the second input interface in the automatic shift mode, and operate the transmission to change the reduction ratio in accordance with the reduction ratio designated by the second input interface in the manual shift mode, and the at least two assist conditions include a condition where the automatic shift mode is being executed.

In the fourteenth aspect, in the manual shift mode, the driver can accelerate the vehicle at a desired timing by changing the reduction ratio by himself or herself. In the automatic shift mode, the driver cannot accelerate the vehicle by changing the reduction ratio. Therefore, in the automatic shift mode, the control circuitry executes the assist control, thereby making it possible to implement the acceleration of the vehicle in response to the driver's request. The second assist condition may include a condition where the automatic shift mode is being executed.

A vehicle according to a fifteenth aspect of the present disclosure may be implemented such that in any one of the first aspect to the fourteenth aspect, the control circuitry is configured to cancel the assist control when at least one of the satisfied assist conditions is no longer satisfied during execution of the assist control.

In the fifteenth aspect, the assist control may be unnecessary in a state in which at least one assist condition of the satisfied assist conditions is no longer satisfied. When such a state occurs, the control circuitry can cancel the assist control and shift to, for example, normal control.

A vehicle according to a sixteenth aspect of the present disclosure may be implemented such that in any one of the first aspect to the fifteenth aspect, the control circuitry is configured to cancel the assist control when the operation amount decreases to be equal to or less than a preset first operation amount during execution of the assist control.

In the sixteenth aspect, in a state in which the operation amount of the first input interface is equal to or less than the first operation amount, the acceleration of the vehicle is not required by the driver, and the assist control may be unnecessary. When such a state occurs, the control circuitry can cancel the assist control and shift to, for example, normal control.

A vehicle according to a seventeenth aspect of the present disclosure may be implemented such that in any one of the first aspect to the sixteenth aspect, the vehicle further includes a transmission configured to transmit power generated by the traveling drive source to the wheel, in which the control circuitry is configured to cancel the assist control when a reduction ratio selected by the transmission is changed during execution of the assist control.

In the seventeenth aspect, when the reduction ratio selected by the transmission is changed, the output to be increased from the reference output may be unnecessary or may change. The control circuitry can cope with the fluctuation of the output to be increased from the reference output by canceling the assist control being executed.

A vehicle according to an eighteenth aspect of the present disclosure may be implemented such that in any one of the first aspect to the seventeenth aspect, the control circuitry is configured to increase an output of the traveling drive source from the reference output to the assist output at a first velocity when the assist control is started, and decrease the output of the traveling drive source from the assist output to the reference output at a second velocity when the assist control being executed is canceled, and a magnitude of the first velocity is larger than a magnitude of the second velocity.

According to the eighteenth aspect, a sudden output fluctuation is prevented when the assist control is started and canceled. At the start of the assist control, the output of the traveling drive source increases at the first velocity in order to respond to the acceleration request from the driver. When the assist control is canceled, the output of the traveling drive source gently decreases at the second velocity in order not to give the driver a sense of deceleration. Therefore, the driving feeling of the driver is improved.

A vehicle control method according to a nineteenth aspect of the present disclosure includes: acquiring information on an operation amount input to an input interface, the input interface being configured to receive an input of an operation for accelerating or decelerating a vehicle; determining a reference output of a traveling drive source of the vehicle based on the operation amount; determining whether at least two preset assist conditions are satisfied; determining an assist output increased from the reference output when at least two of the assist conditions are satisfied; controlling the traveling drive source based on the assist output when at least two of the assist conditions are satisfied; and controlling the traveling drive source based on the reference output when the number of the satisfied assist conditions is less than two.

According to the nineteenth aspect, the same effects as those of the vehicle according to each aspect of the present disclosure can be achieved. A part or all of the control method of the present disclosure may be implemented by, for example, a circuit such as a CPU or an LSI, an IC card, or a single module. A plurality of elements included in the control method according to the present disclosure may be implemented by one device or may be implemented by being shared by two or more devices.

The present disclosure may be a computer program that causes a computer to execute the control method according to each aspect of the present disclosure. Such a computer program can achieve the same effects as those of the control method according to each aspect of the present disclosure. The computer program may be, for example, a program recorded on a non-transitory, tangible, computer-readable storage medium, or may be read from a storage medium using a drive device of the storage medium and installed on a computer. The computer program may be, for example, a program that can be distributed via a transmission medium such as the Internet, or may be downloaded and installed on a computer.

The functions of the elements disclosed in the present specification can be executed using a circuit or a processing circuit including a general-purpose processor, a dedicated processor, an integrated circuit, an ASIC, a related circuit, and/or a combination thereof implemented or programmed to execute the disclosed functions. The processor includes a transistor and other circuits, and thus the processor is regarded as a processing circuit or a circuit. In the present disclosure, the circuit, the unit, or the section are hardware that executes the listed functions or hardware that is programmed to execute the listed functions. The hardware may be the hardware disclosed in the present specification, or may be other known hardware implemented or programmed to execute the listed functions. When the hardware is a processor considered as a kind of circuit, the circuit, the section, or the unit is a combination of hardware and software, and the software is used for the hardware and/or processor.

Numbers such as ordinal numbers and quantities used in the present specification are all examples for specifically describing the technique of the present disclosure, and the present disclosure is not limited to the exemplified numbers. The connection relation between the components is exemplified for specifically describing the technique of the present disclosure, and the connection relation for implementing the functions of the present disclosure is not limited thereto.

Since the scope of the present disclosure is defined by the appended claims rather than the description of the specification so that the present disclosure can be implemented in various forms without departing from the scope of the essential features thereof, the exemplary embodiments and modifications are exemplary and not restrictive. All modifications within the claims and the scope thereof or equivalents within the claims and the scope thereof are intended to be included in the claims.

What is claimed is:

1. A vehicle comprising:
a wheel;
a traveling drive source configured to drive the wheel;
a first input interface configured to receive an input of an operation for accelerating the vehicle; and
a control circuitry configured to control the traveling drive source based on an operation amount input to the first input interface, wherein the control circuitry is configured to:
determine a reference output that is an output of the traveling drive source based on the operation amount;
determine whether at least two preset assist conditions are satisfied;
execute assist control to control the traveling drive source based on an assist output increased from the reference output when the at least two assist conditions are satisfied; and
execute normal control to control the traveling drive source based on the reference output when the number of the satisfied assist conditions is less than two.

2. The vehicle according to claim 1, wherein
the at least two assist conditions include a first assist condition related to the operation for accelerating the vehicle and a second assist condition related to a state of the vehicle.

3. The vehicle according to claim 2, wherein
the control circuitry is configured to execute the assist control when the first assist condition and the second assist condition are satisfied.

4. The vehicle according to claim 1, wherein
the at least two assist conditions include a condition where a change amount of the operation amount is equal to or larger than a threshold that fluctuates in accordance with the operation amount.

5. The vehicle according to claim 4, wherein
the threshold fluctuates to decrease as the operation amount increases.

6. The vehicle according to claim 5, wherein
the change amount of the operation amount is, with respect to the operation amount at a first timing, a change amount of the operation amount at a second timing that is later than the first timing, and
the threshold corresponds to the operation amount at the first timing.

7. The vehicle according to claim 1, wherein
the traveling drive source includes an internal combustion engine and a rotary electric machine, and
the control circuitry is configured to, in the assist control, increase outputs of both the internal combustion engine and the rotary electric machine from the respective reference outputs of the internal combustion engine and the rotary electric machine.

8. The vehicle according to claim 1, further comprising:
a transmission configured to transmit power generated by the traveling drive source to the wheel, wherein
the control circuitry is configured to:
determine an additional output based on a reduction ratio selected by the transmission, the operation amount, and a rotation speed of the traveling drive source; and
determine the assist output by adding the additional output to the reference output.

9. The vehicle according to claim 8, wherein
the control circuitry is configured to cancel the assist control when the determined additional output is 0 during execution of the assist control.

10. The vehicle according to claim 1, further comprising:
a transmission configured to transmit power generated by the traveling drive source to the wheel, wherein
the at least two assist conditions include a condition where a reduction ratio selected by the transmission is equal to or less than a preset reduction ratio.

11. The vehicle according to claim 1, wherein
the traveling drive source includes an internal combustion engine and a rotary electric machine,
the vehicle further comprises a drive structure connected to the internal combustion engine and the rotary electric machine such that power generated by the internal combustion engine and the rotary electric machine is transmitted and configured to transmit the power applied from the internal combustion engine and the rotary electric machine to the wheel,
the drive structure includes an input shaft to which the power generated by the internal combustion engine and the rotary electric machine is transmitted, and
the at least two assist conditions include a condition where a rotation speed of the input shaft is less than a preset first rotation speed.

12. The vehicle according to claim 1, wherein
the traveling drive source includes an internal combustion engine and a rotary electric machine,
the vehicle further comprises a drive structure connected to the internal combustion engine and the rotary electric machine such that power generated by the internal combustion engine and the rotary electric machine is transmitted and configured to transmit the power applied from the internal combustion engine and the rotary electric machine to the wheel, and
the at least two assist conditions include a condition where the drive structure is in a state of transmitting the power generated by the internal combustion engine to the wheel.

13. The vehicle according to claim 1, wherein
the traveling drive source includes an internal combustion engine and a rotary electric machine,
the vehicle further comprises:
a battery electrically connected to the rotary electric machine; and
a temperature sensor configured to detect a temperature of the battery, and
the at least two assist conditions include a condition where the temperature of the battery detected by the temperature sensor is equal to or lower than a preset first temperature.

14. The vehicle according to claim 1, further comprising:
a transmission configured to transmit power generated by the traveling drive source to the wheel;
a second input interface configured to receive an input of an operation for designating a reduction ratio selected by the transmission; and
a transmission actuator configured to change the reduction ratio selected by the transmission, wherein
the control circuitry is configured to:
selectively execute control in a manual shift mode and an automatic shift mode;
in the automatic shift mode, control the transmission actuator regardless of the operation input to the second input interface; and
in the manual shift mode, operate the transmission to change the reduction ratio in accordance with the reduction ratio designated by the second input interface, and
the at least two assist conditions include a condition where the automatic shift mode is being executed.

15. The vehicle according to claim 1, wherein
the control circuitry is configured to cancel the assist control when at least one of the satisfied assist conditions is no longer satisfied during execution of the assist control.

16. The vehicle according to claim 1, wherein
the control circuitry is configured to cancel the assist control when the operation amount decreases to be equal to or less than a preset first operation amount during execution of the assist control.

17. The vehicle according to claim 1, further comprising:
a transmission configured to transmit power generated by the traveling drive source to the wheel, wherein
the control circuitry is configured to cancel the assist control when a reduction ratio selected by the transmission is changed during execution of the assist control.

18. The vehicle according to claim 1, wherein
the control circuitry is configured to:
increase an output of the traveling drive source from the reference output to the assist output at a first velocity when the assist control is started; and
decrease the output of the traveling drive source from the assist output to the reference output at a second velocity when the assist control being executed is canceled, and
a magnitude of the first velocity is larger than a magnitude of the second velocity.

19. A vehicle control method comprising:
acquiring information on an operation amount input to an input interface, the input interface being configured to receive an input of an operation for accelerating or decelerating a vehicle;
determining a reference output of a traveling drive source of the vehicle based on the operation amount;
determining whether at least two preset assist conditions are satisfied;
determining an assist output increased from the reference output when the at least two assist conditions are satisfied;
controlling the traveling drive source based on the assist output when the at least two assist conditions are satisfied; and
controlling the traveling drive source based on the reference output when the number of the satisfied assist conditions is less than two.
